(19) United States
(12) Patent Application Publication
(10) Pub. No.: US 2014/0087118 A1
(43) Pub. Date: Mar. 27, 2014

(54) Multi-Layer Facade Film

(71) Applicant: Bernd Kronenberg, Wegberg (DE)

(72) Inventor: Bernd Kronenberg, Wegberg (DE)

(21) Appl. No.: 14/091,463

(22) Filed: Nov. 27, 2013

Related U.S. Application Data
(63) Continuation of application No. PCT/DE2012/100048, filed on Feb. 27, 2012.

(30) Foreign Application Priority Data
Jun. 3, 2011 (DE) 10 2011 050 829.5

(51) Int. Cl. B32B 27/12

(52) U.S. Cl. CPC B32B 27/12
USPC 428/86

(57) ABSTRACT

A multi-layer façade film having a fleece layer and two plastic film layers, the fleece layer being sandwiched between the plastic film layers and bonded thereto. Each layer is elastically extensible in all directions. The fleece is made of a thermoplastic elastomer in a melt-blown process. Each film layer includes an elastically deformable thermoplastic urethane and is connected to the fleece as an extrusion coating. The façade film has a yield strength of at least 40% in the length and width directions of the film. A 50 mm wide film strip has a tensile strength of at least 120 N, a maximum S_{d} value of 1.5 m for vapor permeability, and a value corresponding to a water column of at least 8 m for water impermeability.

### BACKGROUND INFORMATION

1. Field of the Invention

The invention relates to the field of films used in building construction. More particularly, the invention relates to façade films.

2. Discussion of the Prior Art

Conventional façade films typically have two layers, namely, a fleece layer, which can, for example, be fiberglass and which is firmly affixed with a film layer that is a plastic film. The layers are, for example, laminated or adhesively affixed, in order to provide the plastic film with a slightly higher tensile strength.

Other films, unconventional for the industry, are known that are made of a rubber-elastic material, and indeed, are constructed of just one layer of this rubber-elastic material, whereby this layer, known in the field as a “rubber film”, has pores, for example, 25 to 60 pores per square centimeter. These pores can be created by needling the rubber film. Such rubber films typically have a corresponding S_{d} value of approximately 3 m, as they are constructed to be open or permeable to vapor diffusion. The thickness of the layer of air that is equivalent to the water vapor diffusion is referred to as the S_{d} value, and is a measurement that is typically used in construction physics to designate the resistance that a component layer provides against water vapor diffusion. The S_{d} value is descriptive of the diffusion resistance, in that it indicates the thickness that a calm layer of air has to have, in order to have the same diffusion flow through it, in a stationary state and under the same marginal conditions, that would flow through the component layer under consideration. Smaller S_{d} values thus represent a greater permeability to vapor diffusion.

Regarding water impermeability or water-tightness, the unconventional rubber films mentioned above, i.e., needled films, also have an impermeability value of approximately 200 mm water column, measured according to DIN EN 1928, Method B, at a test climate: DIN 50014-23/50-2. The highest possible values are desirable when measuring water impermeability.

Conventional façade films, in contrast to the mentioned unconventional rubber films, have S_{d} values of a meter or smaller with regard to openness to vapor diffusion and, regarding water-impermeability, have values of 10 m water column or higher.

Façade films differ basically from films that are used in above-ground building construction, for example, for finishing out an attic. In a roof construction, the films are intended to be placed above the thermal insulation layer, such as, for example, a mineral fleece. Normally roof beams are placed on the outside of the films, to which the actual roof tiles or elements of the roof are then affixed. The roof elements may be made of concrete or may be clay roof tiles, for example. These roof elements provide a water-shedding plane or surface of the roof, so that the film is placed in parallel to this water-shedding plane. The difference is that in a building façade, the façade film itself is the water-shedding plane.

What is needed is a façade film that has excellent values, on the one hand, for openness to vapor diffusion, and on the other, for water impermeability. What is further needed is such a façade film that has excellent mechanical resistance values against loads that may be exerted on the façade film. What is yet further needed is a façade sealing strip that simplifies the use of the façade film, has the advantages of the façade film, and is also easy to use right on site.

### BRIEF SUMMARY OF THE INVENTION

The invention is a multi-layer façade film that comprises at least three-layers, i.e., two outer film layers and sandwiched therebetween a fleece layer, rather than the conventional two layers. Unexpectedly, permeability for vapor diffusion is not negatively influenced to any significant degree by the fleece layer, due to the openness of the fleece layer. Normally, the person of skill in the art would expect that the use of two film layers would have a significant negative impact on the ability of the multi-layer façade film to diffuse vapor, compared to conventional films, and, because of this, the use of two film layers in a three-layer construction of the film is initially unexpected. The ability to diffuse vapor is, however, determined by the structure of the film.

In fact, it was a surprise to discover that, with a suitable selection of conventional films, it is possible to achieve an ability to diffuse vapor that is not in any way less effective than that of conventional films. In other words, the multi-layer façade film according to the invention has an S_{d} value that is at the most 1.5 m. S_{d} values of even lower than 1 m were attained in practical experiments. The water impermeability may be significantly improved, compared to that of conventional façade films, so that, with regard to water-tightness, the façade film according to the invention has values of at least 8 m and, in practical experiments, values of as much as 20 m water column were attained.

The multi-layer façade film according to the invention has good mechanical strength, as a result of the combination of an all-directional elastically deformable fleece layer and the stretchable film layers. A fleece that is a melt blown product provides the desired elastic deformability along with the corresponding ability to return to its original dimensions. The fleece is elastically deformable in the length, width, and diagonal directions of the fleece, that is, all-directional. As a result, the entire film is stretchable, without inducing delamination. As is known, delamination can occur with the use of a fleece layer that is not stretchable or is stretchable in one direction only. After stretching, the entire façade film according to the invention returns to its original form and, thus, to its original properties. This is because of the elastic properties of all three layers. The stretchability allows the façade film to be pulled over a pipe end after cutting a small opening in the façade film. If the dimension of the opening is smaller than the diameter of the pipe, the film then fits tight against the pipe. As a result, the façade film according to the invention has the impermeability and elasticity properties of a so-called rubber or EPDM film, but also has the advantages of a much higher permeability for vapor diffusion, a lower weight per unit of area, and lower production costs.

Furthermore, good mechanical strength is ensured by a close bond of the fleece layer with the two film layers, which works against delamination. The close bond is ensured by using a fleece that is a thermoplastic polymer and by using film layers that also contain elastically deformable material and that are bonded with the fleece as an extrusion coating. The material forming the film layer is directly bonded with the previously produced fleece in an extrusion process using a wide slit jet. In this manner, in addition to a true mechanical meshing, partial homogeneous fusing takes place between the melt-warm film and the fleece. This bonding process eliminates the need to use adhesives or bonding agents and, consequently, the façade film may be produced very economically. The façade film also has a lower weight per unit of area, which makes it easier to use, for example, when the façade film is to be applied in an upper story of a building.

### DETAILED DESCRIPTION OF THE INVENTION

The multi-layer façade film according to the invention is a sandwiched construction that includes two outer layers of film with a fleece layer sandwiched therebetween. The two film layers as well as the fleece layer are all-directionally elastically deformable, so that the façade film has an elastic strength of at least 40% in the length direction and also in the width direction and a tear or yield strength of at least 120 N loading on a 50 mm wide film strip. Thus, the façade film according to the invention doesn't tear until it has been stretched to more than 40% of its original expanse. In practical tests for yield strength, it was found that the façade film according to the invention did not tear until values of greater than 65% at a load in the length direction of the film and greater than 85% at a load in the width direction of the film. Length and width directions are determined by the production process. The film is a rolled product that is wrapped around a drum, and the length direction is the direction of the film that is wrapped around a drum in the circumferential, i.e., radial, direction of the drum and the width direction is the direction that extends parallel to the axial direction of the drum.

The stretchability of the façade film, together with the high yield strength of 120 N, as measured on a 50 mm wide test strip, the 50 mm width being typical in the field of use, ensures that, for example, the pressure and vacuum effects of wind loads exerted on a façade that is back-aired do not result in a failure of the film and, particularly, do not result in the façade film tearing.

Advantageously, each of the film layers may be formed from a monolithic plastic film. “Monolithic” means that the film does not show pores per se, which may be mechanically created as necessary, but rather, is constructed of a material in which the molecular structure has thicker and thinner areas, whereby the thinner areas of the molecular structure determine the permeability of the film. It is known in the industry that the suppliers of the material that is used for making the film typically provide information about the particular relationship between layer thickness of the manufactured product and the resulting vapor diffusion permeability and water impermeability. Depending on the material used and its indicated properties, it is therefore possible to adjust the layer thickness to achieve the desired properties of the façade film.

Advantageously, the fleece and/or the film layers may each be formed from a thermoplastic urethane (TPU). The layer thickness of the TPU may be so adjusted, that the façade film has the desired values for vapor diffusion permeability and water-impermeability. In addition, an outer film layer made of TPU has excellent wear resistance values. The façade film might be dragged at the construction site over the edge of scaffolding or over protruding nail or screw heads, or a tool dragged along the façade film, so, it is an advantage that the façade film have a high resistance strength, to reduce the likelihood that its surface will be damaged and the properties of the façade film thereby negatively affected.

In particular, making the fleece as well as the film layers from TPU provides an excellent opportunity to achieve a close bond between the fleece and the two film layers in an extrusion coating process, without having to use bonding agents, which themselves have undesirable effects on the cost and weight of the façade film.

The fleece layer produced in a melt blown process is self-curing, i.e., thermally curing. This works against a delamination of the façade film, when for example, vacuum forces are exerted on the film, so that, in such instances, the fleece layer does not act as an easily separable layer between the two film layers.

Advantageously, the fleece layer has a low weight per unit of area and can be produced with a weight of greater than 40 g/m² and at most 150 g/m². This façade film is so lightweight that, particularly when working with films of greater dimensions, the weight of the film itself does not lead to undesired mechanical loads on the film, joints, or seams.

Advantageously, the fleece may be constructed to be hydrophobic, in order to avoid in this way, a negative influence on the insulation value of the fleece because of the uptake of moisture. Also, at temperatures lower than 0 degree C., there is a danger that freezing water will result in destruction of the film.

Advantageously, the fleece layer may also include a swell material. In this way, the façade film may provide self-sealing properties. If a nail is driven through the façade film or the surface of the façade film is otherwise damaged, moisture can penetrate the façade film. The swell material that is in the fleece layer will then swell up and, in this manner, prevent further ingress of moisture, so that the end result is that the façade film, despite damage, remains watertight.

A material that is referred to in the industry as a super absorber material may be used as the swell material. The swell material may be applied directly to the fibers of the fleece or be applied as a sheath to the fibers. It may also be incorporated as a separate material in the fleece. Swell material in granulate form, for example, may be strewn throughout the fleece, after the fleece is bonded with a first film layer and before the fleece layer is bonded with the second film layer.

Furthermore, the fleece may be constructed to be fire-resistant, so that the façade film according to the invention may be used in the greatest possible variety of applications. When constructing a fire-resistant fleece, it may be particularly advantageous to construct the fleece to be self-extinguishing, which provides particularly effective fire protection. Melamine resin or other conventional materials, which provide the façade film with the desired fire-resistant or self-extinguishing properties, may be added to the fleece. In this way, the use of conventional and, thus, less expensive, raw materials may be used to achieve the desired product properties of the façade film according to the invention. It may be particularly advantageous to provide embodiments of the fleece layer such, that the façade film has the desired product properties. For example, additional materials may be added into the hollow spaces in the fleece.

The façade film according to the invention may be provided as a prefabricated façade sealing strip. Such façade sealing strips are used, for example, in transition areas from large area facades to breaks in the façade, such as doors or windows. It is desirable to provide a sealed transition between the particular façade break and the rest of the façade and sealing strips are used to achieve this. Accordingly, such façade sealing strips are cut to be narrower than the normal façade film that is typically provided as a rolled product. For example, the façade sealing strips can have a width of approximately 20 cm, whereas the façade film per se has a width of approximately 1 m to 1.5 m.

The façade sealing strips may be prefabricated not only with the desired dimensions, i.e., narrow width, but also provided with additional sealing elements, to make them as easy as possible to work with. Thus, for example, it is advantageous to provide the façade sealing strip with an additional sealing profile, which may be made of an elastomeric or a foam material. For example, such a sealing profile strip may be constructed as a keder, or be made of an SK or butyl material and be adhesively affixed to the façade film on the façade sealing strip.

Depending on the embodiment of the façade film, a vapor diffusion permeable film may also be created, which, aside from its elasticity and yield strength, satisfies essentially the demands for vapor diffusion permeability and wind impermeability, as well as water impermeability, so that the final product of the façade film according to the invention for use on building facades is a product that has good tensile strength and provides good protection against delamination.

It may be an advantage to flame the fleece layer on its two surfaces, in order to improve its bond with bordering film layers.

It is understood that the embodiments described herein are merely illustrative of the present invention. Variations in the construction of the façade film according to the invention may be contemplated by one skilled in the art without limiting the intended scope of the invention herein disclosed and as defined by the following claims.

What is claimed is:

1. A multi-layer façade film having a length dimension and a width dimension, the multi-layer façade film comprising:
two film layers, each film layer formed of a plastic film; and
a fleece layer, the two film layers bonded to each side of the fleece layer as an extrusion coating;
wherein the fleece layer is made of a thermoplastic polymer in a melt-blown process and is all-directionally elastically stretchable;
wherein each film layer is also all-directionally elastically stretchable and contains an elastically deformable thermoplastic urethane (TPU);
and wherein the multi-layer façade film has an elastic strength of at least 40% in the length direction and the width direction, a yield strength, measured on a 50 mm wide film strip, of at least 120 N, a vapor permeability having an S_{d} value of at most 1.5 m, and a water impermeability value that corresponds to a water column of at least 8 m.

2. The multi-layer façade film of claim 1, wherein the two film layers are each formed of a monolithic plastic film.

3. The multi-layer façade film of claim 1, wherein the fleece is constructed of a TPU.

4. The multi-layer façade film of claim 1, wherein the two film layers are each formed of the TPU.

5. The multi-layer façade film of claim 1, wherein the fleece layer contains a swell material.

6. The multi-layer façade film of claim 5, wherein the fleece layer contains a super absorber material that is evenly distributed in the fleece layer.

7. The multi-layer façade film of claim 1, wherein the fleece has a weight per unit of area of at most 150 gm/².

8. The multi-layer façade film of claim 1, wherein the fleece is hydrophobic.

9. The multi-layer façade film of claim 1, wherein the fleece is fire-resistant.

10. The multi-layer façade film of claim 1, wherein the fleece is self-extinguishing.

13. The multi-layer façade film of claim 1, embodied as a narrow strip.

14. The multi-layer façade film of claim 13, further comprising a sealing profile that is bonded with the narrow strip.
